(19) United States
(12) Patent Application Publication
(10) Pub. No.: US 2026/0349575 A1
(43) Pub. Date: Nov. 5, 2026

(54) FILTERING INPUTS TO A USER DEVICE

(71) Applicant: QUALCOMM Incorporated, San Diego, CA (US)

(72) Inventors: Jason FILOS, Newark, NJ (US); Shuhua ZHANG, San Diego, CA (US); Yinyi GUO, San Diego, CA (US); Jaw BELANGER, Escondido, CA (US)

(21) Appl. No.: 19/119,674

(22) PCT Filed: Sep. 19, 2023
(86) PCT No.: PCT/US2023/074578

§ 371 Date: Apr. 9, 2025

(30) Foreign Application Priority Data
Nov. 8, 2022 (GR) 20220100915

(51) Int. Cl. G06F 3/0481

(52) U.S. Cl. CPC G06F 3/0481

(57) ABSTRACT

In some aspects, a user device may determine that an actor, in addition to a user of the user device, is present in a vicinity of the user device. The user device may obtain an input to the user device. The user device may determine, based at least in part on determining that the actor is present in the vicinity of the user device, whether the input is from the user or the actor. The user device may accept the input based at least in part on a determination that the input is from the user or reject the input based at least in part on a determination that the input is from the actor. Numerous other aspects are described.

### CROSS-REFERENCE TO RELATED APPLICATION

This Patent Application claims priority to Greek Patent Application No. 20220100915, filed on Nov. 8, 2022, entitled “FILTERING INPUTS TO A USER DEVICE,” and assigned to the assignee hereof. The disclosure of the prior Application is considered part of and is incorporated by reference into this Patent Application.

### FIELD OF THE DISCLOSURE

Aspects of the present disclosure generally relate to user devices and, for example, to filtering inputs to a user device.

### BACKGROUND

A user device may include a display for displaying a user interface (e.g., a graphical user interface). The user interface may permit interactions between a user of the user device and the user device. In some cases, the user may interact with the user interface to operate and/or control the user device to produce a desired result. For example, the user may interact with the user interface of the user device to cause the user device to perform an action.

### SUMMARY

Some aspects described herein relate to a method. The method may include determining, by a user device, that an actor, in addition to a user of the user device, is present in a vicinity of the user device. The method may include obtaining, by the user device, an input to the user device. The method may include determining, by the user device and based at least in part on determining that the actor is present in the vicinity of the user device, whether the input is from the user or the actor. The method may include accepting the input based at least in part on a determination that the input is from the user or rejecting the input based at least in part on a determination that the input is from the actor.

Some implementations described herein relate to a system. The system may include one or more memories and one or more processors coupled to the one or more memories. The system may be configured to obtain sensor data relating to an environment or a condition of a user device. The system may be configured to determine, based at least in part on the sensor data, that an actor, in addition to a user of the user device, is present in a vicinity of the user device. The system may be configured to determine, based at least in part on determining that the actor is present in the vicinity of the user device, whether an input to the user device is to be accepted or rejected.

Some implementations described herein relate to an apparatus. The apparatus may include means for determining that an actor, in addition to a user of a user device, is present in a vicinity of the user device. The apparatus may include means for determining, based at least in part on determining that the actor is present in the vicinity of the user device, whether an input to the user device is indicative of an anomalous input. The apparatus may include means for rejecting the input based at least in part on a determination that the input is indicative of the anomalous input.

Some implementations described herein relate to a non-transitory computer-readable medium that stores a set of instructions for a user device. The set of instructions, when executed by one or more processors of the user device, may cause the user device to obtain sensor data relating to an environment or a condition of the user device. The set of instructions, when executed by one or more processors of the user device, may cause the user device to determine, based at least in part on the sensor data, that an actor, in addition to a user of the user device, is present in a vicinity of the user device. The set of instructions, when executed by one or more processors of the user device, may cause the user device to determine, based at least in part on determining that the actor is present in the vicinity of the user device, whether an input to the user device is from the user or the actor. The set of instructions, when executed by one or more processors of the user device, may cause the user device to selectively perform an action indicated by the input based at least in part on a determination of whether the input to the user device is from the user or the actor.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIGS. 3A-3D are diagrams illustrating an example associated with filtering inputs to a user device, in accordance with the present disclosure.

FIG. 4 is a flowchart of an example process associated with filtering inputs to a user device.

FIG. 5 is a flowchart of an example process associated with filtering inputs to a user device.

FIG. 6 is a flowchart of an example process associated with filtering inputs to a user device.

FIG. 7 is a flowchart of an example process associated with filtering inputs to a user device.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A user device may include an input device, such as a keyboard, a mouse, one or more buttons, a touchpad, and/or a touchscreen, among other examples. A user may provide inputs to the user device via the input device, and the inputs may cause the user device to perform actions indicated by the inputs (e.g., opening or closing a file or an application, scrolling in a user interface, displaying typing in a user interface, composing an email message, adjusting a volume of a speaker, adjusting a brightness of a display, or the like). In some examples, an actor, other than the user, may be near enough to the user device to also provide inputs to the user device. For example, the actor may be a child (e.g., that is grabbing at a smartphone) or a pet (e.g., that is walking across a keyboard). Thus, the actor's inputs may be unintentional and/or for a purpose undesired by the user. However, the user device may be unable to differentiate between the user's inputs and the actor's inputs. Accordingly, the user device may perform actions indicated by the actor's inputs even if such actions are unintended and/or undesired by the user. As a result, the user device may expend significant resources (e.g., processor resources, memory resources, and/or power resources, among other examples) performing unwanted actions indicated by the inputs of the actor, performing corrective actions to undo or correct the unwanted actions, or the like.

Some techniques and apparatuses described herein enable filtering of inputs to a user device. In some aspects, sensor data (e.g., microphone data, camera data, and/or touch sensor data, among other examples) collected by the user device may be used to determine whether an actor, in addition to a user of the user device, is present in a vicinity of the user device. For example, audio context detection may be performed to determine whether the actor is present. Based at least in part on determining that the actor is present, inputs to the user device may be processed to identify anomalous inputs. For example, a machine learning model may be employed to classify inputs as anomalous (e.g., as being from the actor) or as not anomalous (e.g., as being from the user). On the basis of the actor being present, the machine learning model may make such classifications with a high degree of accuracy (e.g., in contrast to making such classifications without knowledge as to whether the actor is present), thereby reducing false positives and false negatives.

Inputs identified as anomalous (e.g., as being from the actor) may be rejected. That is, the user device may refrain from performing actions indicated by inputs identified as anomalous. Inputs identified as not anomalous (e.g., as being from the user) may be accepted. That is, the user device may perform actions indicated by inputs identified as not anomalous.

Thus, inputs from the actor may be filtered out from the inputs that are acted on by the user device. In this way, resources (e.g., processor resources, memory resources, and/or power resources, among other examples) of the user device, that may have otherwise been used to perform unwanted actions indicated by inputs of the actor and/or used to perform corrective actions for those unwanted actions, may be conserved.

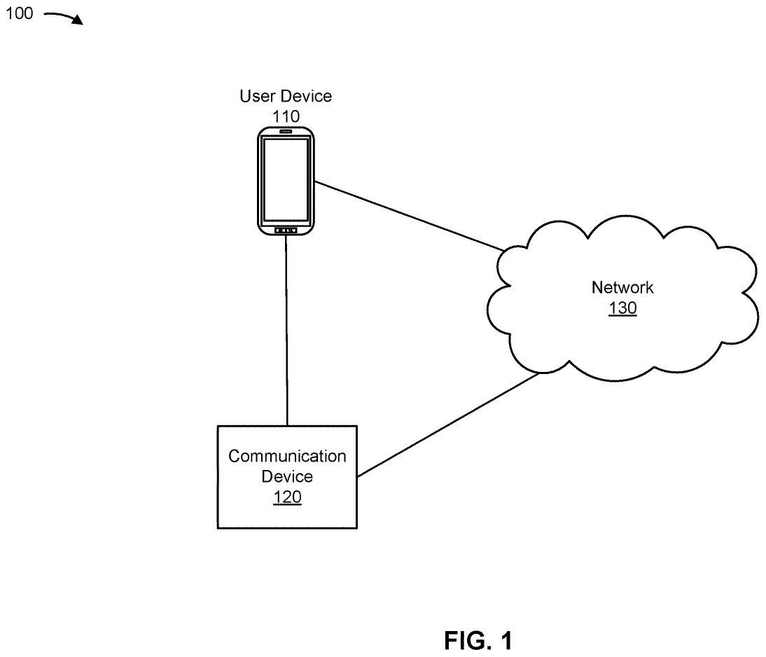

FIG. 1 is a diagram of an example environment 100 in which systems and/or methods described herein may be implemented. As shown in FIG. 1, environment 100 may include a user device 110, a communication device 120, and a network 130. Devices of environment 100 may interconnect via wired connections, wireless connections, or a combination of wired and wireless connections.

The user device 110 may include one or more devices capable of receiving, generating, storing, processing, and/or providing information associated with filtering inputs to the user device 110, as described elsewhere herein. The user device 110 may include a communication device and/or a computing device. For example, the user device 110 may include a communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. In some implementations, the user device 110 may include a keyboard and/or a mouse (e.g., that is capable of wired or wireless communication with a computing device).

The communication device 120 may include one or more devices capable of receiving, generating, storing, processing, providing, and/or routing information associated with filtering inputs to the user device, as described elsewhere herein. The communication device 120 may include a communication device and/or a computing device. For example, the communication device 120 may include a server, such as an application server, a client server, a web server, a database server, a host server, a proxy server, a virtual server (e.g., executing on computing hardware), or a server in a cloud computing system. In some implementations, the communication device 120 may include computing hardware used in a cloud computing environment. In some implementations, the communication device 120 may include a user device (e.g., that is capable of wired or wireless communication with a keyboard, a mouse, or the like), as described herein.

The network 130 may include one or more wired and/or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 130 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

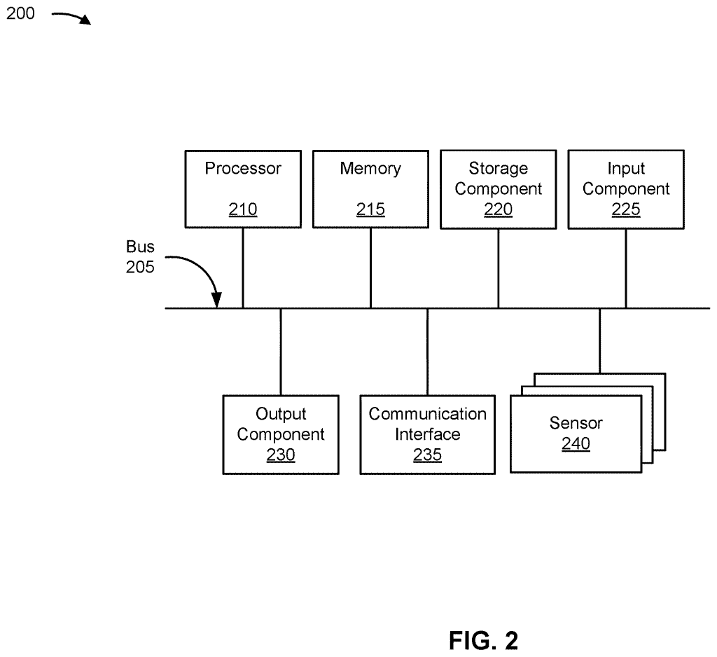

FIG. 2 is a diagram illustrating example components of a device 200, in accordance with the present disclosure. Device 200 may correspond to user device 110 and/or communication device 120. In some aspects, user device 110 and/or communication device 120 may include one or more devices 200 and/or one or more components of device 200. As shown in FIG. 2, device 200 may include a bus 205, a processor 210, a memory 215, a storage component 220, an input component 225, an output component 230, a communication interface 235, and/or one or more sensors 240.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function.

Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Sensor 240 includes one or more devices capable of detecting a characteristic associated with device 200 (e.g., a characteristic relating to a physical environment of the device 200 or a characteristic relating to a condition of the device 200). Sensor 240 may include one or more photodetectors (e.g., one or more photodiodes), one or more cameras, one or more microphones, one or more gyroscopes (e.g., a micro-electro-mechanical system (MEMS) gyroscope), one or more magnetometers, one or more accelerometers, one or more location sensors (e.g., a global positioning system (GPS) receiver or a local position system (LPS) device), one or more motion sensors, one or more temperature sensors, one or more pressure sensors, and/or one or more touch sensors, among other examples.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for determining that an actor, in addition to a user of a user device, is present in a vicinity of the user device; means for obtaining an input to the user device; means for determining, based at least in part on determining that the actor is present in the vicinity of the user device, whether the input is from the user or the actor; means for accepting the input based at least in part on a determination that the input is from the user or rejecting the input based at least in part on a determination that the input is from the actor; or the like. Additionally, or alternatively, device 200 may include means for obtaining sensor data relating to an environment or a condition of a user device; means for determining, based at least in part on the sensor data, that an actor, in addition to a user of the user device, is present in a vicinity of the user device; means for determining, based at least in part on determining that the actor is present in the vicinity of the user device, whether an input to the user device is to be accepted or rejected; or the like. Additionally, or alternatively, device 200 may include means for determining that an actor, in addition to a user of a user device, is present in a vicinity of the user device; means for determining, based at least in part on determining that the actor is present in the vicinity of the user device, whether an input to the user device is indicative of an anomalous input; and means for rejecting the input based at least in part on a determination that the input is indicative of the anomalous input. Additionally, or alternatively, device 200 may include means for obtaining sensor data relating to an environment or a condition of a user device; means for determining, based at least in part on the sensor data, that an actor, in addition to a user of the user device, is present in a vicinity of the user device; means for determining, based at least in part on determining that the actor is present in the vicinity of the user device, whether an input to the user device is from the user or the actor; means for selectively performing an action indicated by the input based at least in part on a determination of whether the input to the user device is from the user or the actor; or the like. In some aspects, such means may include one or more components of device 200 described in connection with FIG. 2, such as bus 205, processor 210, memory 215, storage component 220, input component 225, output component 230, communication interface 235, and/or sensors 240.

The number and arrangement of components shown in FIG. 2 are provided as an example. In practice, device 200 may include additional components, fewer components, different components, or differently arranged components than those shown in FIG. 2.

Additionally, or alternatively, a set of components (e.g., one or more components) of device 200 may perform one or more functions described as being performed by another set of components of device 200.

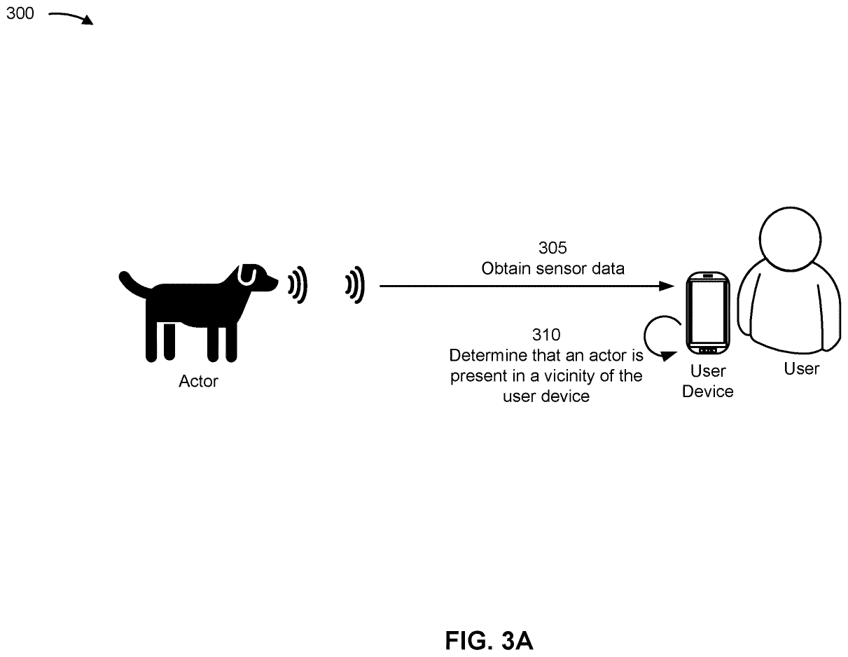

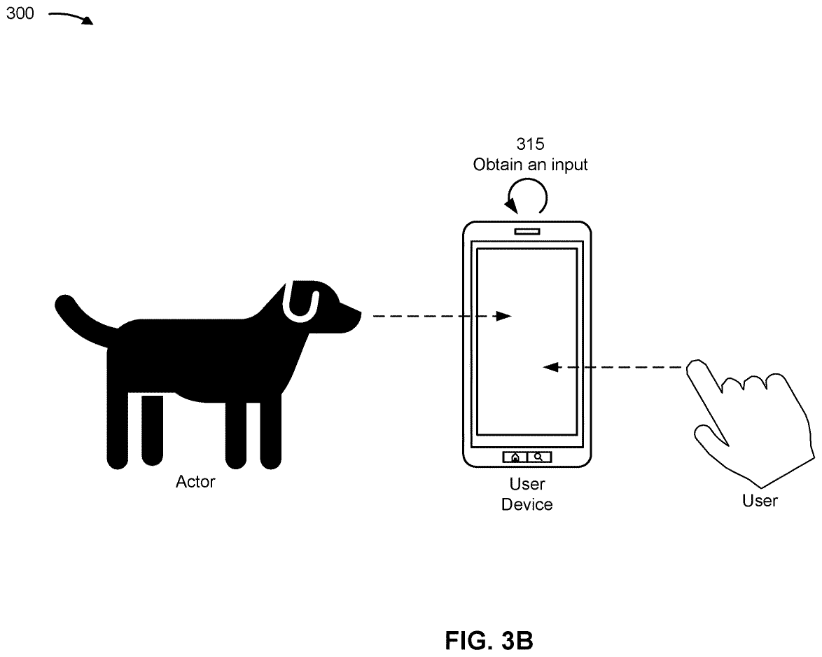

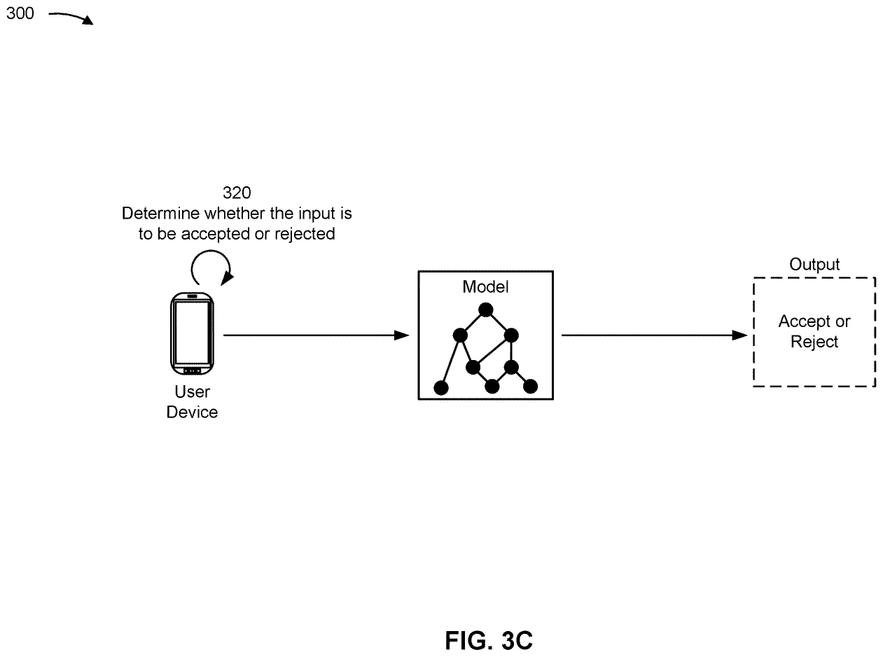

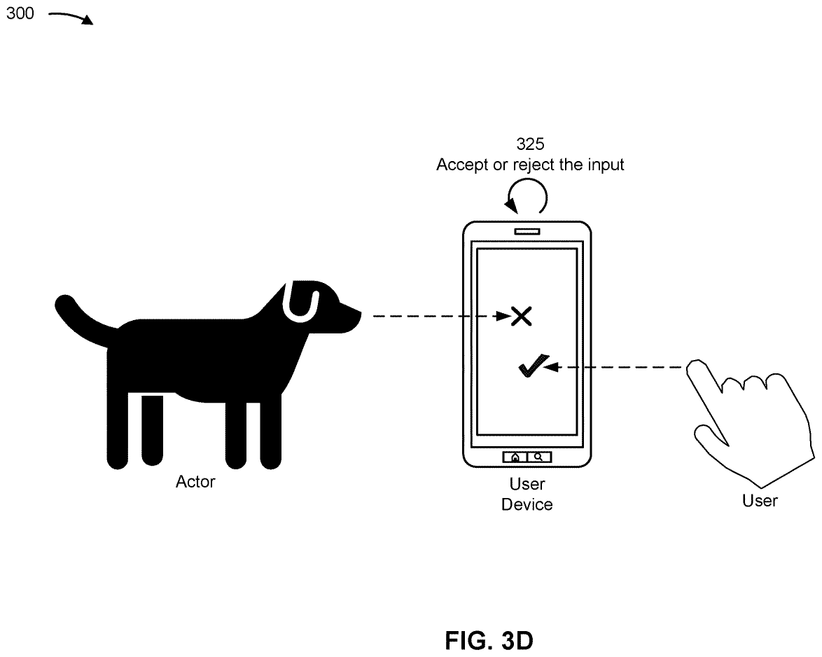

FIGS. 3A-3D are diagrams illustrating an example 300 associated with filtering inputs to a user device, in accordance with the present disclosure. As shown in FIGS. 3A-3D, example 300 includes a user device (e.g., user device 110). The user device may be used by a user. That is, the user may provide inputs to the user device indicating actions that are to be performed by the user device. Thus, techniques described herein provide filtering of inputs to the user device to allow such intended inputs to the user device made by the user and to block unintended inputs to the user device made by another actor.

As shown in FIG. 3A, and by reference number 305, the user device may obtain sensor data relating to an environment and/or a condition of the user device. For example, the sensor data may relate to sound in the environment of the user device and/or visual aspects in the environment of the user device, among other examples. Additionally, or alternatively, the sensor data may relate to touches on the user device and/or pressure on the user device, among other examples. The user device may obtain the sensor data using a microphone, a camera, a touch sensor, and/or a pressure sensor, among other examples. In some aspects, the user device may provide, and a communication device (e.g., a server) may obtain, the sensor data.

As shown by reference number 310, the user device may determine that an actor, in addition to (e.g., other than) the user of the user device, is present in a vicinity of the user device. The actor may be a person (e.g., a child) or an animal (e.g., a pet). The user device's vicinity may be a room or a building in which the user device is located, may be within a threshold distance (e.g., 10 feet, 25 feet, 50 feet, or the like) of the user device, may be within a detection range of one or more sensors of the user device, or the like.

The user device may determine that the actor is present in the vicinity of the user device based at least in part on the sensor data. For example, the sensor data may indicate sounds in the environment of the user device and/or visual aspects in the environment of the user device that are indicative of the actor being present. In some aspects, to determine that the actor is present, the user device may perform audio context detection (which may also be referred to as audio event classification). Audio context detection may include operations that enable the user device to classify nearby objects (e.g., living beings and/or inanimate objects) based at least in part on sound in the user device's environment. For example, using audio context detection, the user device may classify the sounds made by a crying baby, an ambulance siren, a cat, or the like. To perform audio context detection, the user device may use a machine learning model (e.g., that uses an artificial neural network, a transformer, or the like) trained to output a classification of sound data that is input to the machine learning model. Accordingly, the user device may determine that the actor is present in the vicinity of the user device based at least in part on a result of the audio context detection. For example, if the audio context detection classifies sounds in the user device's environment as a person (e.g., a child, a baby, or the like) or an animal (e.g., a dog, a cat, or the like), then the user device may determine that the actor is present. In contrast, if the audio context detection does not classify sounds in the user device's environment as a person or an animal (e.g., the audio context detection classifies the sounds as an inanimate object, such as a television, a motorcycle, or the like), then the user device may not determine that the actor is present.

Additionally, or alternatively, to determine that the actor is present, the user device may process images obtained by a camera of the user device using a computer vision technique (e.g., a convolutional neural network technique). To perform the computer vision technique, the user device may use a machine learning model (e.g., that uses an artificial neural network, a transformer, or the like) trained to output a classification of one or more images that are input to the machine learning model. Accordingly, the user device may determine that the actor is present in the vicinity of the user device based at least in part on a result of the computer vision technique, in a similar manner as described above. Additionally, or alternatively, to determine that the actor is present, the user device may monitor inputs to an input device (e.g., a keyboard, a touchpad, a touchscreen, or the like) of the user device. For example, if the inputs to the input device are indicative of multiple actors providing the inputs (e.g., the user and the actor), then the user device may determine that the actor is present in the vicinity of the user device. The inputs may be indicative of multiple actors based at least in part on a frequency of the inputs, a location of the inputs (e.g., on a keyboard, a touchpad, a touchscreen), a quantity of concurrent inputs (e.g., inputs overlapping wholly or partially in time), or the like. In some aspects, the user device may determine that the actor is present based at least in part on the inputs to the input device if the audio context detection and/or the computer vision technique is unable to identify whether the actor is present. Based at least in part on determining that the actor is present, the user device may activate an input filter of the user device.

In some aspects, the communication device, that obtained the sensor data from the user device, may determine whether the actor is present in the vicinity of the user device based at least in part on the sensor data, in a similar manner as described above. For example, the communication device may determine whether the actor is present using audio context detection, a computer vision technique, and/or by monitoring inputs to the input device of the user device, among other examples.

As shown in FIG. 3B, and by reference number 315, the user device may obtain an input to the user device. The input may be to the input device of the user device. For example, the input may be a touch screen input, a keyboard input, a touchpad input, a mouse input, and/or a speech input, among other examples. The input may include a single action (e.g., a single key press on a keyboard, a single touch gesture on a touchscreen, or the like) or a series of actions (e.g., multiple key presses on a keyboard, multiple touch gestures on a touchscreen, or the like).

While the actor is present in the vicinity of the user device, the input may be provided by the user or the actor. In some aspects, the user device may obtain multiple inputs to the user device concurrently (e.g., overlapping wholly or partially in time). For example, the user device may obtain a first input to the user device concurrently with a second input to the user device.

In some cases, the first input may be from the user and the second input may be from the actor (e.g., while the actor is present in the vicinity of the user device). In some aspects, the user device may provide, and the communication device may obtain, information associated with the input (e.g., the multiple inputs), thereby enabling the communication device to perform assessments of the input, as described herein.

As shown in FIG. 3C, and by reference number 320, the user device (e.g., using the input filter) may determine whether the input (e.g., the multiple inputs) to the user device is to be accepted (e.g., allowed to pass through the input filter) or rejected (e.g., blocked by the input filter). In some aspects, determining whether the input is to be accepted or rejected may include determining whether the input is indicative of an anomalous input (e.g., determining whether the input is anomalous). In some aspects, determining whether the input is to be accepted or rejected may include determining whether the input is from the user or the actor. In the case of multiple concurrent inputs provided to the user device, the user device may determine whether one of the first input and the second input is from the user and whether the other of the first input and the second input is from the actor. For example, the user device may determine that the first input is from the user and the second input is from the actor.

The user device may determine whether the input is to be accepted or rejected (e.g., whether the input is indicative of an anomalous input and/or whether the input is from the user or the actor) based at least in part on determining that the actor is present in the vicinity of the user device. For example, without knowledge that the actor is present, determining whether the input is anomalous may be difficult and may result in a false positive or false negative.

However, based at least in part on determining that the actor is present, the user device may determine whether the input is anomalous with higher accuracy. In some aspects, the user device may determine whether the input is to be accepted or rejected (e.g., whether the input is indicative of an anomalous input and/or whether the input is from the user or the actor) further based at least in part on a type of the input device of the user device (e.g., a keyboard, a touchscreen, or the like) and/or a type of the actor (e.g., a dog, a cat, a baby, or the like). In some aspects, the user device may refrain from determining whether the input is to be accepted or rejected if the user device does not determine that the actor is present. For example, if the user device does not determine that the actor is present, then the input may be accepted.

As shown, the user device may determine whether the input is to be accepted or rejected (e.g., whether the input is indicative of an anomalous input and/or whether the input is from the user or the actor) using a machine learning model. The machine learning model may be trained to identify an anomalous input to a user device when an actor, in addition to a user of the user device, is present in a vicinity of the user device. In some aspects, the machine learning model may be trained to identify an anomalous input for the particular type of input device of the user device. For example, a first machine learning model may be trained to identify an anomalous input for a touchscreen, a second machine learning model may be trained to identify an anomalous input for a keyboard, and so forth. In some aspects, the machine learning model may be trained to identify an anomalous input for the particular type of actor that is determined to be present. For example, a first machine learning model may be trained to identify an anomalous input when a cat is present in a vicinity of a user device, a second machine learning model may be trained to identify an anomalous input when a baby is present in a vicinity of a user device, and so forth.

The machine learning model may be trained by a supervised learning technique, a semi-supervised learning technique, or an unsupervised learning technique. In some aspects, a training procedure for the machine learning model may include performing a forward propagation (“forward propagation” or “forward computation” may refer to a computation that is performed from an input layer, through one or more hidden layers, to an output layer of a machine learning model to generate an output of the machine learning model) using the machine learning model (e.g., using data indicating an input to a user device and data indicating whether an actor is present in a vicinity of the user device as an input to the machine learning model), and applying a loss function to a result of the forward computation to identify a degree by which an output of the machine learning model deviates from an actual result (e.g., whether the input is from a user or an actor). Moreover, the training procedure may include a back-propagation of the machine learning model using a result of the loss function to determine adjustments to weights used by the machine learning model (“back-propagation” may include traversing a machine learning model backwards, from an output layer through one or more hidden layers, using an algorithm for tuning weights of the machine learning model). The machine learning model may be updated using the adjustments to the weights. The training procedure described above is one example technique for training the machine learning model, and one or more other training procedures may be used to train the machine learning model.

In some aspects, the machine learning model may be trained by a supervised learning technique using labeled data relating to inputs to a user device (e.g., labeled with “accept” or “reject”), sensor data obtained by the user device (e.g., by a microphone, a camera, or like), and/or labeled data relating to the presence of an actor in a vicinity of a user device (e.g., audio context detection data). In some aspects, the machine learning model may be trained by a semi-supervised learning technique using unlabeled data relating to inputs to a user device, sensor data obtained by the user device (e.g., by a microphone, or a camera, or like), and/or labeled data relating to the presence of an actor in a vicinity of a user device (e.g., audio context detection data).

Data relating to inputs to a user device, sensor data, and/or data relating to the presence of an actor in a vicinity of a user device may be a set of observations for training the machine learning model. The set of observations may include a feature set, and the feature set may include a set of variables. Thus, a specific observation may include a set of variable values (or feature values) corresponding to the set of variables. The feature set may be extracted from structured data and/or based on an input from an operator. As an example, a feature set for the set of observations may include whether an actor is present, a type of actor that is present, a type of an input (e.g., a key press, a tapping touch gesture, a swiping touch gesture, or the like), a frequency of inputs, a location of an input (e.g., a location on a keyboard, a location on a touch screen, or the like), an accuracy of an input (e.g., whether a keyboard input includes a single key press or multiple key presses of nearby keys, whether a tapping touch gesture is centered on an input element or off-centered on an input element, or the like), and/or whether inputs are concurrent, among other examples. The set of observations may be associated with a target variable, which may represent a variable having a numeric value, a variable having a numeric value that falls within a range of values or has some discrete possible values, a variable that is selectable from one of multiple options, and/or a variable having a Boolean value. For example, the target variable may be a classification of accept or reject, a classification of anomalous or not anomalous, a classification of user or actor, a score indicating a probability that an input is anomalous, a score indicating a probability that an input is provided by an actor, or the like.

Thus, the target variable may represent a value that the machine learning model is being trained to predict, and the feature set may represent the variables that are input to the machine learning model to predict a value for the target variable. The machine learning model may be trained to recognize patterns in the feature set that lead to a target variable value. The machine learning model may be trained using the set of observations and using one or more machine learning algorithms, such as a regression algorithm, a decision tree algorithm, a neural network algorithm, a k-nearest neighbor algorithm, a support vector machine algorithm, or the like.

Once the machine learning model is trained (or re-trained), the user device may use the machine learning model to determine whether the input is to be accepted or rejected (e.g., whether the input is indicative of an anomalous input and/or whether the input is from the user or the actor). That is, the machine learning model may output information that identifies a value for the target variable for a new observation. Additionally, or alternatively, the output may include information that identifies a cluster to which the new observation belongs and/or information that indicates a degree of similarity between the new observation and one or more other observations (e.g., such as when unsupervised learning is employed).

In some aspects, the communication device may determine whether the input is to be accepted or rejected (e.g., whether the input is indicative of an anomalous input and/or whether the input is from the user or the actor), in a similar manner as described above. For example, the communication device may determine whether the input is to be accepted or rejected (e.g., whether the input is indicative of an anomalous input and/or whether the input is from the user or the actor) based at least in part on the sensor data obtained by the communication device and/or the information associated with the input obtained by the communication device. In some aspects, the communication device may provide, and the user device may obtain, an indication of whether the input is to be accepted or rejected (e.g., based at least in part on the communication device determining whether the input is to be accepted or rejected)

As shown in FIG. 3D, and by reference number 325, the user device may accept or reject the input. In some aspects, the user device may accept the input based at least in part on a determination that the input is to be accepted or reject the input based at least in part on a determination that the input is to be rejected. For example, the user device may accept the input based at least in part on a determination that the input is not indicative of an anomalous input or reject the input based at least in part on a determination that the input is indicative of an anomalous input. As another example, the user device may accept the input based at least in part on a determination that the input is from the user or reject the input based at least in part on a determination that the input is from the actor. In the case of multiple concurrent inputs provided to the user device, the user device may accept a first input based at least in part on a determination that the first input is to be accepted (e.g., a determination that the first input is not indicative of an anomalous input and/or a determination that the first input is from the user), and the user device may reject a second input based at least in part on a determination that the second input is to be rejected (e.g., a determination that the second input is indicative of an anomalous input and/or a determination that the second input is from the actor).

To accept or reject the input, the user device may selectively perform an action indicated by the input (e.g., based at least in part on a determination of whether the input is to be accepted or rejected, such as a determination of whether the input is indicative of an anomalous input or a determination of whether the input is from the user or the actor). To accept the input, the user device may perform an action indicated by the input. To reject the input, the user device may refrain from performing an action indicated by the input. The action indicated by the input may be opening or closing a file or an application, scrolling in a user interface, displaying typing in a user interface, composing an email message, adjusting a volume of a speaker, or adjusting a brightness of a display, among other examples.

In some aspects, the user device may perform one or more preventative actions based at least in part on rejecting the input (e.g., based at least in part on determining that the input is indicative of an anomalous input and/or that the input is from the actor). In some aspects, a preventative action may include disabling the input device (e.g., a keyboard, a touchscreen, or the like) of the user device based at least in part on rejecting the input. The user device may disable the input device for a particular time duration or until the user provides an indication that the input device is to be enabled. In some aspects, the user device may disable an area of the input device associated with the input that is rejected. For example, if the input is detected at an upper-left corner of a touchscreen, then the user device may disable the upper-left corner of the touchscreen (while leaving a remainder of the touchscreen enabled). In some aspects, a preventative action may include causing the user device to provide an alert (e.g., an audible alert or a visual alert) that is intended to alert the user of the rejected input and/or to deter the actor from providing further inputs. In some aspects, the user device may perform the one or more preventative actions based at least in part on a threshold quantity of rejected inputs occurring (e.g., within a particular time period).

In some aspects, the user device may perform the techniques described herein in an always-on manner. For example, the user device may continuously monitor for an actor being present in the vicinity of the user device and/or may continuously determine whether to accept or reject inputs when the actor is present in the vicinity of the user device. In this way, unintended or undesired inputs may be filtered at the user device. Accordingly, resources (e.g., processor resources, memory resources, and/or power resources, among other examples) of the user device, that may have otherwise been used to perform unwanted actions indicated by inputs of the actor and/or used to perform corrective actions for those unwanted actions, may be conserved.

As indicated above, FIGS. 3A-3D are provided as an example. Other examples may differ from what is described with respect to FIGS. 3A-3D.

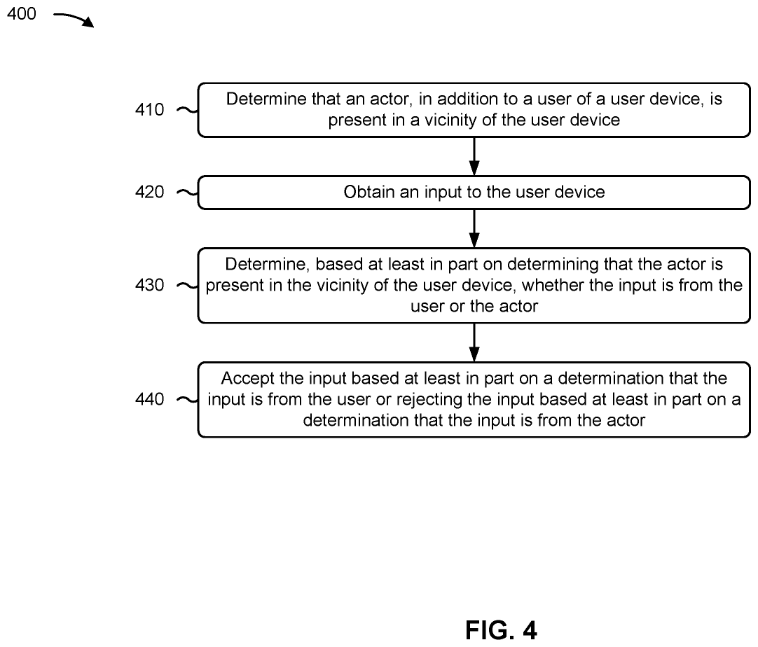

FIG. 4 is a flowchart of an example process 400 associated with filtering inputs to a user device. In some aspects, one or more process blocks of FIG. 4 are performed by a user device (e.g., user device 110). In some aspects, one or more process blocks of FIG. 4 are performed by another device or a group of devices separate from or including the user device, such as a communication device (e.g., communication device 120). Additionally, or alternatively, one or more process blocks of FIG. 4 may be performed by one or more components of device 200, such as processor 210, memory 215, storage component 220, input component 225, output component 230, communication interface 235, and/or sensor 240.

As shown in FIG. 4, process 400 may include determining that an actor, in addition to a user of a user device, is present in a vicinity of the user device (block 410). For example, the user device may determine that an actor, in addition to a user of the user device, is present in a vicinity of the user device, as described above.

As further shown in FIG. 4, process 400 may include obtaining an input to the user device (block 420). For example, the user device may obtain an input to the user device, as described above.

As further shown in FIG. 4, process 400 may include determining, based at least in part on determining that the actor is present in the vicinity of the user device, whether the input is from the user or the actor (block 430). For example, the user device may determine, based at least in part on determining that the actor is present in the vicinity of the user device, whether the input is from the user or the actor, as described above.

As further shown in FIG. 4, process 400 may include accepting the input based at least in part on a determination that the input is from the user or rejecting the input based at least in part on a determination that the input is from the actor (block 440). For example, the user device may accept the input based at least in part on a determination that the input is from the user or reject the input based at least in part on a determination that the input is from the actor, as described above.

Process 400 may include additional aspects, such as any single aspect or any combination of aspects described below and/or in connection with one or more other processes described elsewhere herein.

In a first aspect, the input is a touch screen input, a keyboard input, a touchpad input, a mouse input, or a speech input.

In a second aspect, alone or in combination with the first aspect, determining that the actor is present in the vicinity of the user device is based at least in part on sensor data obtained at the user device.

In a third aspect, alone or in combination with one or more of the first and second aspects, the sensor data is obtained by a microphone of the user device, a camera of the user device, or a touch sensor of the user device.

In a fourth aspect, alone or in combination with one or more of the first through third aspects, determining that the actor is present in the vicinity of the user device includes performing audio context detection, and determining that the actor is present in the vicinity of the user device based at least in part on a result of the audio context detection.

In a fifth aspect, alone or in combination with one or more of the first through fourth aspects, the input is a first input and the first input is obtained concurrently with a second input, determining whether the input is from the user or the actor includes determining that the first input is from the user and the second input is from the actor, and accepting or rejecting the input includes accepting the first input, based at least in part on a determination that the first input is from the user, and rejecting the second input based at least in part on a determination that the second input is from the actor.

In a sixth aspect, alone or in combination with one or more of the first through fifth aspects, determining whether the input is from the user or the actor includes determining whether the input is from the user or the actor using a machine learning model.

In a seventh aspect, alone or in combination with one or more of the first through sixth aspects, the machine learning model is trained to identify an anomalous input to a user device when an actor, in addition to a user of the user device, is present in a vicinity of the user device.

In an eighth aspect, alone or in combination with one or more of the first through seventh aspects, the machine learning model is trained by a semi-supervised learning technique or a supervised learning technique.

In a ninth aspect, alone or in combination with one or more of the first through eighth aspects, accepting the input includes performing an action indicated by the input.

In a tenth aspect, alone or in combination with one or more of the first through ninth aspects, rejecting the input includes refraining from performing an action indicated by the input.

Although FIG. 4 shows example blocks of process 400, in some aspects, process 400 includes additional blocks, fewer blocks, different blocks, or differently arranged blocks than those depicted in FIG. 4. Additionally, or alternatively, two or more of the blocks of process 400 may be performed in parallel.

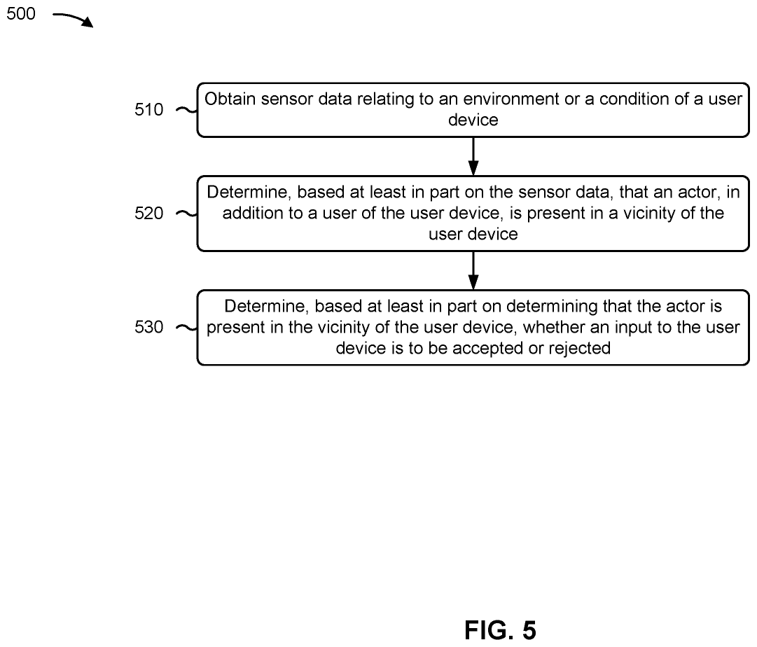

FIG. 5 is a flowchart of an example process 500 associated with filtering inputs to a user device. In some aspects, one or more process blocks of FIG. 5 are performed by a system (e.g., user device 110, a system included in user device 110, communication device 120, a system included in communication device 120, and/or a system that includes user device 110 and/or communication device 120). In some aspects, one or more process blocks of FIG. 5 are performed by another device or a group of devices separate from or including the system.

Additionally, or alternatively, one or more process blocks of FIG. 5 may be performed by one or more components of device 200, such as processor 210, memory 215, storage component 220, input component 225, output component 230, communication interface 235, and/or sensor 240.

As shown in FIG. 5, process 500 may include obtaining sensor data relating to an environment or a condition of a user device (block 510). For example, the system may obtain sensor data relating to an environment or a condition of a user device, as described above.

As further shown in FIG. 5, process 500 may include determining, based at least in part on the sensor data, that an actor, in addition to a user of the user device, is present in a vicinity of the user device (block 520). For example, the system may determine, based at least in part on the sensor data, that an actor, in addition to a user of the user device, is present in a vicinity of the user device, as described above.

As further shown in FIG. 5, process 500 may include determining, based at least in part on determining that the actor is present in the vicinity of the user device, whether an input to the user device is to be accepted or rejected (block 530). For example, the system may determine, based at least in part on determining that the actor is present in the vicinity of the user device, whether an input to the user device is to be accepted or rejected, as described above.

Process 500 may include additional aspects, such as any single aspect or any combination of aspects described below and/or in connection with one or more other processes described elsewhere herein.

In a first aspect, the input is a touch screen input, a keyboard input, a touchpad input, a mouse input, or a speech input.

In a second aspect, alone or in combination with the first aspect, the sensor data is obtained by a microphone of the user device, a camera of the user device, or a touch sensor of the user device.

In a third aspect, alone or in combination with one or more of the first and second aspects, process 500 includes performing audio context detection, and determining that the actor is present in the vicinity of the user device based at least in part on a result of the audio context detection.

In a fourth aspect, alone or in combination with one or more of the first through third aspects, process 500 includes accepting the input based at least in part on a determination that the input is from the user or rejecting the input based at least in part on a determination that the input is from the actor.

In a fifth aspect, alone or in combination with one or more of the first through fourth aspects, the input is a first input that is concurrent with a second input to the user device, determining whether the input is to be accepted or rejected includes determining that the first input is from the user and the second input is from the actor, and accepting or rejecting the input includes accepting the first input, based at least in part on a determination that the first input is from the user, and rejecting the second input based at least in part on a determination that the second input is from the actor.

In a sixth aspect, alone or in combination with one or more of the first through fifth aspects, process 500 includes determining whether the input is to be accepted or rejected using a machine learning model.

In a seventh aspect, alone or in combination with one or more of the first through sixth aspects, the machine learning model is trained to identify an anomalous input to a user device when an actor, in addition to a user of the user device, is present in a vicinity of the user device.

In an eighth aspect, alone or in combination with one or more of the first through seventh aspects, the machine learning model is trained by a semi-supervised learning technique or a supervised learning technique.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

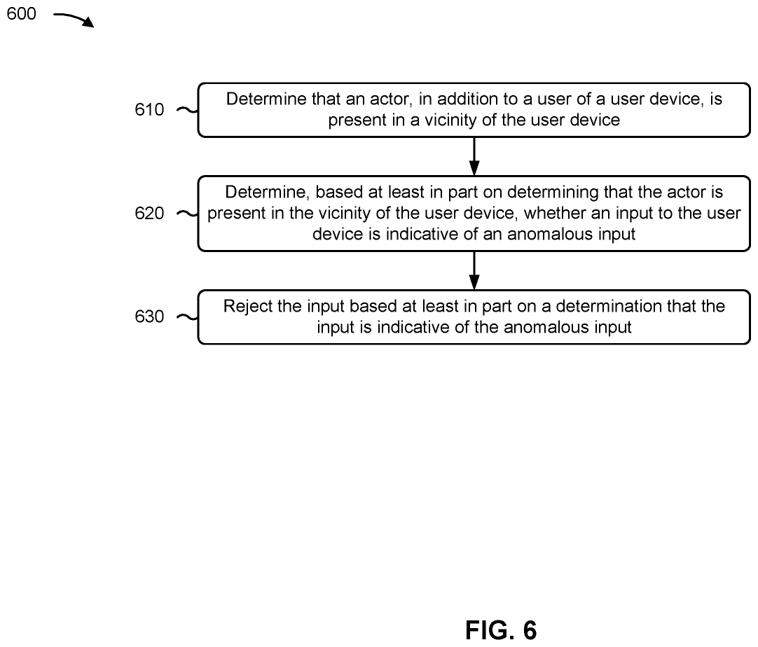

FIG. 6 is a flowchart of an example process 600 associated with filtering inputs to a user device. In some aspects, one or more process blocks of FIG. 6 are performed by an apparatus (e.g., user device 110 or an apparatus thereof, or communication device 120 or an apparatus thereof). In some aspects, one or more process blocks of FIG. 6 are performed by another device or a group of devices separate from or including the apparatus. Additionally, or alternatively, one or more process blocks of FIG. 6 may be performed by one or more components of device 200, such as processor 210, memory 215, storage component 220, input component 225, output component 230, communication interface 235, and/or sensor 240.

As shown in FIG. 6, process 600 may include determining that an actor, in addition to a user of a user device, is present in a vicinity of the user device (block 610). For example, the apparatus may determine that an actor, in addition to a user of a user device, is present in a vicinity of the user device, as described above.

As further shown in FIG. 6, process 600 may include determining, based at least in part on determining that the actor is present in the vicinity of the user device, whether an input to the user device is indicative of an anomalous input (block 620). For example, the apparatus may determine, based at least in part on determining that the actor is present in the vicinity of the user device, whether an input to the user device is indicative of an anomalous input, as described above.

As further shown in FIG. 6, process 600 may include rejecting the input based at least in part on a determination that the input is indicative of the anomalous input (block 630). For example, the apparatus may reject the input based at least in part on a determination that the input is indicative of the anomalous input, as described above.

Process 600 may include additional aspects, such as any single aspect or any combination of aspects described below and/or in connection with one or more other processes described elsewhere herein.

In a first aspect, the input is a touch screen input, a keyboard input, a touchpad input, a mouse input, or a speech input.

In a second aspect, alone or in combination with the first aspect, determining that the actor is present in the vicinity of the user device includes determining that the actor is present in the vicinity of the user device based at least in part on sensor data obtained at the user device.

In a third aspect, alone or in combination with one or more of the first and second aspects, the sensor data is obtained by a microphone of the user device, a camera of the user device, or a touch sensor of the user device.

In a fourth aspect, alone or in combination with one or more of the first through third aspects, determining that the actor is present in the vicinity of the user device includes performing audio context detection, and determining that the actor is present in the vicinity of the user device based at least in part on a result of the audio context detection.

In a fifth aspect, alone or in combination with one or more of the first through fourth aspects, determining whether the input is indicative of the anomalous input includes determining whether the input is indicative of the anomalous input using a machine learning model.

In a sixth aspect, alone or in combination with one or more of the first through fifth aspects, rejecting the input includes refraining from performing an action indicated by the input.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

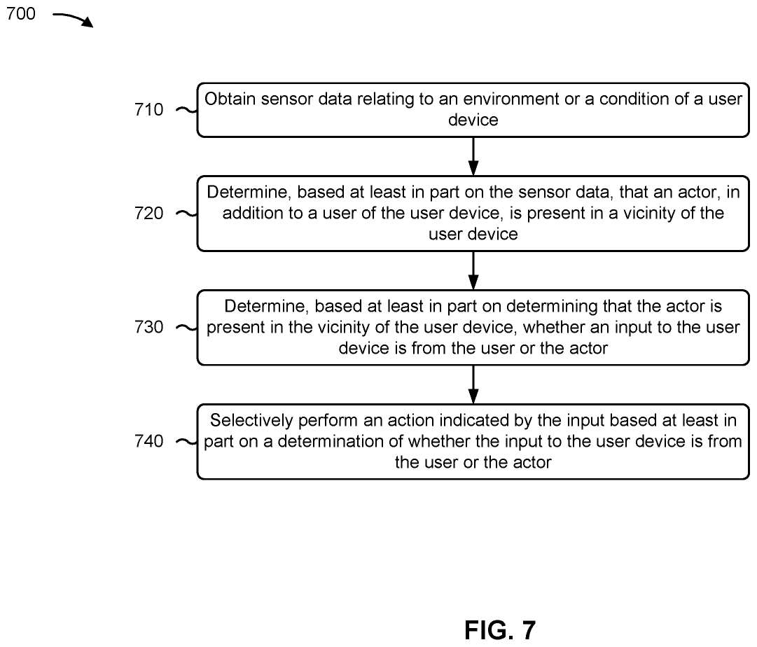

FIG. 7 is a flowchart of an example process 700 associated with filtering inputs to a user device. In some aspects, one or more process blocks of FIG. 7 are performed by a user device (e.g., user device 110). In some aspects, one or more process blocks of FIG. 7 are performed by another device or a group of devices separate from or including the user device, such as a communication device (e.g., communication device 120). Additionally, or alternatively, one or more process blocks of FIG. 7 may be performed by one or more components of device 200, such as processor 210, memory 215, storage component 220, input component 225, output component 230, communication interface 235, and/or sensor 240.

As shown in FIG. 7, process 700 may include obtaining sensor data relating to an environment or a condition of a user device (block 710). For example, the user device may obtain sensor data relating to an environment or a condition of a user device, as described above.

As further shown in FIG. 7, process 700 may include determining, based at least in part on the sensor data, that an actor, in addition to a user of the user device, is present in a vicinity of the user device (block 720). For example, the user device may determine, based at least in part on the sensor data, that an actor, in addition to a user of the user device, is present in a vicinity of the user device, as described above.

As further shown in FIG. 7, process 700 may include determining, based at least in part on determining that the actor is present in the vicinity of the user device, whether an input to the user device is from the user or the actor (block 730). For example, the user device may determine, based at least in part on determining that the actor is present in the vicinity of the user device, whether an input to the user device is from the user or the actor, as described above.

As further shown in FIG. 7, process 700 may include selectively performing an action indicated by the input based at least in part on a determination of whether the input to the user device is from the user or the actor (block 740). For example, the user device may selectively perform an action indicated by the input based at least in part on a determination of whether the input to the user device is from the user or the actor, as described above.

Process 700 may include additional aspects, such as any single aspect or any combination of aspects described below and/or in connection with one or more other processes described elsewhere herein.

In a first aspect, process 700 includes performing audio context detection, and determining that the actor is present in the vicinity of the user device based at least in part on a result of the audio context detection.

In a second aspect, alone or in combination with the first aspect, process 700 includes determining whether the input is from the user or the actor using a machine learning model.

Although FIG. 7 shows example blocks of process 700, in some aspects, process 700 includes additional blocks, fewer blocks, different blocks, or differently arranged blocks than those depicted in FIG. 7. Additionally, or alternatively, two or more of the blocks of process 700 may be performed in parallel.

The following provides an overview of some Aspects of the present disclosure:

Aspect 1: A method, comprising: determining, by a user device, that an actor, in addition to a user of the user device, is present in a vicinity of the user device; obtaining, by the user device, an input to the user device; determining, by the user device and based at least in part on determining that the actor is present in the vicinity of the user device, whether the input is from the user or the actor; and accepting the input based at least in part on a determination that the input is from the user or rejecting the input based at least in part on a determination that the input is from the actor.

Aspect 2: The method of Aspect 1, wherein the input is a touch screen input, a keyboard input, a touchpad input, a mouse input, or a speech input.

Aspect 3: The method of any of Aspects 1-2, wherein determining that the actor is present in the vicinity of the user device is based at least in part on sensor data obtained at the user device.

Aspect 4: The method of Aspect 3, wherein the sensor data is obtained by a microphone of the user device, a camera of the user device, or a touch sensor of the user device.

Aspect 5: The method of any of Aspects 1-4, wherein determining that the actor is present in the vicinity of the user device comprises: performing audio context detection; and determining that the actor is present in the vicinity of the user device based at least in part on a result of the audio context detection.

Aspect 6: The method of any of Aspects 1-5, wherein the input is a first input and the first input is obtained concurrently with a second input, wherein determining whether the input is from the user or the actor comprises: determining that the first input is from the user and the second input is from the actor, and wherein accepting or rejecting the input comprises: accepting the first input, based at least in part on a determination that the first input is from the user, and rejecting the second input based at least in part on a determination that the second input is from the actor.

Aspect 7: The method of any of Aspects 1-6, wherein determining whether the input is from the user or the actor comprises: determining whether the input is from the user or the actor using a machine learning model.

Aspect 8: The method of Aspect 7, wherein the machine learning model is trained to identify an anomalous input to a user device when an actor, in addition to a user of the user device, is present in a vicinity of the user device.

Aspect 9: The method of any of Aspects 7-8, wherein the machine learning model is trained by a semi-supervised learning technique or a supervised learning technique.

Aspect 10: The method of any of Aspects 1-9, wherein accepting the input comprises: performing an action indicated by the input.

Aspect 11: The method of any of Aspects 1-10, wherein rejecting the input comprises: refraining from performing an action indicated by the input.

Aspect 12: A system, comprising: one or more memories; and one or more processors, coupled to the one or more memories, configured to: obtain sensor data relating to an environment or a condition of a user device; determine, based at least in part on the sensor data, that an actor, in addition to a user of the user device, is present in a vicinity of the user device; and determine, based at least in part on determining that the actor is present in the vicinity of the user device, whether an input to the user device is to be accepted or rejected.

Aspect 13: The system of Aspect 12, wherein the input is a touch screen input, a keyboard input, a touchpad input, a mouse input, or a speech input.

Aspect 14: The system of any of Aspects 12-13, wherein the sensor data is obtained by a microphone of the user device, a camera of the user device, or a touch sensor of the user device.

Aspect 15: The system of any of Aspects 12-14, wherein the one or more processors, to determine that the actor is present in the vicinity of the user device, are configured to: perform audio context detection; and determine that the actor is present in the vicinity of the user device based at least in part on a result of the audio context detection.

Aspect 16: The system of any of Aspects 12-15, wherein the one or more processors are further configured to: accept the input based at least in part on a determination that the input is from the user or reject the input based at least in part on a determination that the input is from the actor.

Aspect 17: The system of Aspect 16, wherein the input is a first input that is concurrent with a second input to the user device, wherein the one or more processors, to determine whether the input is to be accepted or rejected, are configured to: determine that the first input is from the user and the second input is from the actor, and wherein the one or more processors, to accept or reject the input, are configured to: accept the first input, based at least in part on a determination that the first input is from the user, and reject the second input based at least in part on a determination that the second input is from the actor.

Aspect 18: The system of any of Aspects 12-17, wherein the one or more processors, to determine whether the input is to be accepted or rejected, are configured to: determine whether the input is to be accepted or rejected using a machine learning model.

Aspect 19: The system of Aspect 18, wherein the machine learning model is trained to identify an anomalous input to a user device when an actor, in addition to a user of the user device, is present in a vicinity of the user device.

Aspect 20: The system of any of Aspects 18-19, wherein the machine learning model is trained by a semi-supervised learning technique or a supervised learning technique.

Aspect 21: An apparatus, comprising: means for determining that an actor, in addition to a user of a user device, is present in a vicinity of the user device; means for determining, based at least in part on determining that the actor is present in the vicinity of the user device, whether an input to the user device is indicative of an anomalous input; and means for rejecting the input based at least in part on a determination that the input is indicative of the anomalous input.

Aspect 22: The apparatus of Aspect 21, wherein the input is a touch screen input, a keyboard input, a touchpad input, a mouse input, or a speech input.

Aspect 23: The apparatus of any of Aspects 21-22, wherein the means for determining that the actor is present in the vicinity of the user device comprises: means for determining that the actor is present in the vicinity of the user device based at least in part on sensor data obtained at the user device.

Aspect 24: The apparatus of Aspect 23, wherein the sensor data is obtained by a microphone of the user device, a camera of the user device, or a touch sensor of the user device.

Aspect 25: The apparatus of any of Aspects 21-24, wherein the means for determining that the actor is present in the vicinity of the user device comprises: means for performing audio context detection; and means for determining that the actor is present in the vicinity of the user device based at least in part on a result of the audio context detection.

Aspect 26: The apparatus of any of Aspects 21-25, wherein the means for determining whether the input is indicative of the anomalous input comprises: means for determining whether the input is indicative of the anomalous input using a machine learning model.

Aspect 27: The apparatus of any of Aspects 21-26, wherein the means for rejecting the input comprises: means for refraining from performing an action indicated by the input.

Aspect 28: A non-transitory computer-readable medium storing a set of instructions, the set of instructions comprising: one or more instructions that, when executed by one or more processors of a user device, cause the user device to: obtain sensor data relating to an environment or a condition of the user device; determine, based at least in part on the sensor data, that an actor, in addition to a user of the user device, is present in a vicinity of the user device; determine, based at least in part on determining that the actor is present in the vicinity of the user device, whether an input to the user device is from the user or the actor; and selectively perform an action indicated by the input based at least in part on a determination of whether the input to the user device is from the user or the actor.

Aspect 29: The non-transitory computer-readable medium of Aspect 28, wherein the one or more instructions, that cause the user device to determine that the actor is present in the vicinity of the user device, cause the user device to: perform audio context detection; and determine that the actor is present in the vicinity of the user device based at least in part on a result of the audio context detection.

Aspect 30: The non-transitory computer-readable medium of any of Aspects 28-29, wherein the one or more instructions, that cause the user device to determine whether the input is from the user or the actor, cause the user device to: determine whether the input is from the user or the actor using a machine learning model.

Aspect 31: An apparatus, comprising a processor; memory coupled with the processor; and instructions stored in the memory and executable by the processor to cause the apparatus to perform the method of one or more of Aspects 1-11.

Aspect 32: A device, comprising a memory and one or more processors coupled to the memory, the one or more processors configured to perform the method of one or more of Aspects 1-11.

Aspect 33: An apparatus, comprising at least one means for performing the method of one or more of Aspects 1-11.

Aspect 34: A non-transitory computer-readable medium storing code, the code comprising instructions executable by a processor to perform the method of one or more of Aspects 1-11.

Aspect 35: A non-transitory computer-readable medium storing a set of instructions, the set of instructions comprising one or more instructions that, when executed by one or more processors of a device, cause the device to perform the method of one or more of Aspects 1-11.

Aspect 36: An apparatus, comprising a processor; memory coupled with the processor, and instructions stored in the memory and executable by the processor to cause the apparatus to perform the steps performed by the one or more processors of one or more of Aspects 12-20.

Aspect 37: A device, comprising a memory and one or more processors coupled to the memory, the one or more processors configured to perform the steps performed by the one or more processors of one or more of Aspects 12-20.

Aspect 38: An apparatus, comprising at least one means for performing the steps performed by the one or more processors of one or more of Aspects 12-20.

Aspect 39: A non-transitory computer-readable medium storing code, the code comprising instructions executable by a processor to perform the steps performed by the one or more processors of one or more of Aspects 12-20.

Aspect 40: A non-transitory computer-readable medium storing a set of instructions, the set of instructions comprising one or more instructions that, when executed by one or more processors of a device, cause the device to perform the steps performed by the one or more processors of one or more of Aspects 12-20.

Aspect 41: A method comprising the steps performed by the one or more processors of one or more of Aspects 12-20.

Aspect 42: An apparatus, comprising a processor; memory coupled with the processor; and instructions stored in the memory and executable by the processor to cause the apparatus to perform steps performed by the means of one or more of Aspects 21-27.

Aspect 43: A device, comprising a memory and one or more processors coupled to the memory, the one or more processors configured to perform steps performed by the means of one or more of Aspects 21-27.

Aspect 44: A non-transitory computer-readable medium storing code, the code comprising instructions executable by a processor to perform steps performed by the means of one or more of Aspects 21-27.

Aspect 45: A non-transitory computer-readable medium storing a set of instructions, the set of instructions comprising one or more instructions that, when executed by one or more processors of a device, cause the device to perform steps performed by the means of one or more of Aspects 21-27.

Aspect 46: A method comprising steps performed by the means of one or more of Aspects 21-27.

Aspect 47: An apparatus, comprising a processor; memory coupled with the processor, and instructions stored in the memory and executable by the processor to cause the apparatus to perform the steps performed by the device of one or more of Aspects 28-30.

Aspect 48: A device, comprising a memory and one or more processors coupled to the memory, the one or more processors configured to perform the steps performed by the device of one or more of Aspects 28-30.

Aspect 49: An apparatus, comprising at least one means for performing the steps performed by the device of one or more of Aspects 28-30.

Aspect 50: A non-transitory computer-readable medium storing code, the code comprising instructions executable by a processor to perform the steps performed by the device of one or more of Aspects 28-30.

Aspect 51: A method comprising the steps performed by the device of one or more of Aspects 28-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method, comprising:
determining, by a user device, that an actor, in addition to a user of the user device, is present in a vicinity of the user device;
obtaining, by the user device, an input to the user device;
determining, by the user device and based at least in part on determining that the actor is present in the vicinity of the user device, whether the input is from the user or the actor; and
accepting the input based at least in part on a determination that the input is from the user or rejecting the input based at least in part on a determination that the input is from the actor.

2. The method of claim 1, wherein the input is a touch screen input, a keyboard input, a touchpad input, a mouse input, or a speech input.

3. The method of claim 1, wherein determining that the actor is present in the vicinity of the user device is based at least in part on sensor data obtained at the user device.

4. The method of claim 3, wherein the sensor data is obtained by a microphone of the user device, a camera of the user device, or a touch sensor of the user device.

5. The method of claim 1, wherein determining that the actor is present in the vicinity of the user device comprises:
performing audio context detection; and
determining that the actor is present in the vicinity of the user device based at least in part on a result of the audio context detection.

6. The method of claim 1, wherein the input is a first input and the first input is obtained concurrently with a second input,
wherein determining whether the input is from the user or the actor comprises:
determining that the first input is from the user and the second input is from the actor, and
wherein accepting or rejecting the input comprises:
accepting the first input, based at least in part on a determination that the first input is from the user, and rejecting the second input based at least in part on a determination that the second input is from the actor.

7. The method of claim 1, wherein determining whether the input is from the user or the actor comprises:
determining whether the input is from the user or the actor using a machine learning model.

8. The method of claim 7, wherein the machine learning model is trained to identify an anomalous input to a user device when an actor, in addition to a user of the user device, is present in a vicinity of the user device.

9. The method of claim 7, wherein the machine learning model is trained by a semisupervised learning technique or a supervised learning technique.

10. The method of claim 1, wherein accepting the input comprises:
performing an action indicated by the input.

11. The method of claim 1, wherein rejecting the input comprises:
refraining from performing an action indicated by the input.

12. A system, comprising:
one or more memories; and
one or more processors, coupled to the one or more memories, configured to:
obtain sensor data relating to an environment or a condition of a user device; determine, based at least in part on the sensor data, that an actor, in addition to a user of the user device, is present in a vicinity of the user device; and
determine, based at least in part on determining that the actor is present in the vicinity of the user device, whether an input to the user device is to be accepted or rejected.

13. The system of claim 12, wherein the input is a touch screen input, a keyboard input, a touchpad input, a mouse input, or a speech input.

14. The system of claim 12, wherein the sensor data is obtained by a microphone of the user device, a camera of the user device, or a touch sensor of the user device.

15. The system of claim 12, wherein the one or more processors, to determine that the actor is present in the vicinity of the user device, are configured to:
perform audio context detection; and
determine that the actor is present in the vicinity of the user device based at least in part on a result of the audio context detection.

16. The system of claim 12, wherein the one or more processors are further configured to:
accept the input based at least in part on a determination that the input is from the user or reject the input based at least in part on a determination that the input is from the actor.

17. The system of claim 16, wherein the input is a first input that is concurrent with a second input to the user device,
wherein the one or more processors, to determine whether the input is to be accepted or rejected, are configured to:
determine that the first input is from the user and the second input is from the actor, and
wherein the one or more processors, to accept or reject the input, are configured to:
accept the first input, based at least in part on a determination that the first input is from the user, and reject the second input based at least in part on a determination that the second input is from the actor.

18. The system of claim 12, wherein the one or more processors, to determine whether the input is to be accepted or rejected, are configured to:
determine whether the input is to be accepted or rejected using a machine learning model.

19. The system of claim 18, wherein the machine learning model is trained to identify an anomalous input to a user device when an actor, in addition to a user of the user device, is present in a vicinity of the user device.

20. The system of claim 18, wherein the machine learning model is trained by a semisupervised learning technique or a supervised learning technique.

21-30. (canceled)
